(19) United States
(12) Patent Application Publication
(10) Pub. No.: US 2017/0075160 A1
(43) Pub. Date: Mar. 16, 2017

(54) SURFACE FRAME FOR DISPLAY MODULE, DISPLAY MODULE AND DISPLAY DEVICE

(71) Applicants: BOE TECHNOLOGY GROUP CO., LTD., Beijing (CN); K-TRONICS(SUZHOU) TECHNOLOGY CO., LTD., Suzhou, Jiangsu (CN)

(72) Inventor: Meng YANG, Beijing (CN)

(21) Appl. No.: 14/913,187

(22) PCT Filed: Sep. 18, 2015
(86) PCT No.: PCT/CN2015/089917

§ 371 Date: Feb. 19, 2016

(30) Foreign Application Priority Data
Apr. 20, 2015 (CN) 201520240061.5

(51) Int. Cl. G02F 1/1333

(52) U.S. Cl. CPC G02F 1/133308; G02F 1/133385; G02F 2001/133317; G02F 2001/133331; G02F 2001/133325

(57) ABSTRACT

The present invention provides a surface frame for a display module, a display module and a display device. The surface frame comprises a first support portion for supporting an optical film and a light guide plate and arranged surrounding three edges of the optical film and the light guide plate; a second support portion for supporting a liquid crystal panel and arranged surrounding three edges of the liquid crystal panel; a side frame connected to a rear shell; and a connection portion for connecting the side frame to outer sides of the first support portion and the second support portion.

### FIELD OF THE INVENTION

The present invention belongs to the technical field of display devices, and particularly relates to a surface frame for a display module, a display module and a display device.

### BACKGROUND OF THE INVENTION

As shown in FIG. 1, a display module of a liquid crystal display device mainly consists of three portions, i.e., a surface frame 10, a liquid crystal panel 20 and a backlight module 30. The backlight module 30 includes a LED light bar 33, a cooling fin 32, a light guide plate 35, an optical film 36, a reflector 37, a back plate 34 and an intermediate frame 31. The intermediate frame 31 and the surface frame 10 are arranged at two sides of the liquid crystal panel 20, respectively, to clamp and secure the liquid crystal panel 20.

The inventor has found that there are at least the following problems in the prior art: large-size commercial display modules are mostly side-type all-in-one machines which are large in size, volume and weight and high in cost. It is very difficult to assemble components of such a huge display module according to the prior art, and it is inconvenient for maintenance in the event of failure.

### SUMMARY OF THE INVENTION

In view of the difficulty in assembling the existing large-size display modules, the present invention provides a surface frame for a display module in which the intermediate frame is omitted, in order to simplify the mounting procedure.

According to one aspect of the present invention, there is provided a surface frame for a display module, including: a first support portion for supporting an optical film and a light guide plate and arranged surrounding three edges of the optical film and the light guide plate; a second support portion for supporting a liquid crystal panel and arranged surrounding three edges of the liquid crystal panel; a side frame connected to a rear shell; and a connection portion for connecting the side frame to outer sides of the first support portion and the second support portion.

According to embodiments of the present invention, the surface frame may be made of an aluminum profile, and the surface frame may be integrally formed.

According to another aspect of the present invention, there is provided a display module, including a liquid crystal panel, a cooling fin, an optical film, a light guide plate, a rear shell, and the surface frame for a display module according to the present invention. The cooling fin may be arranged between the first support portion of the surface frame and the rear shell, the optical film and the light guide plate may be arranged inside a space defined by the first support portion of the surface frame and the cooling fin, the liquid crystal panel may be arranged on the second support portion of the surface frame, and the rear shell may be connected to the side frame of the surface frame.

According to embodiments of the present invention, the display module may further include a LED light bar arranged on a side of the first support portion adjacent to the light guide plate.

According to embodiments of the present invention, the display module may further include glass arranged at a light outgoing side of the liquid crystal panel.

According to embodiments of the present invention, the second support portion of the surface frame may be provided with a groove for receiving the glass and an edge of the liquid crystal panel.

According to embodiments of the present invention, the display module may further include a surface frame decorating plate. The liquid crystal panel is arranged between the glass and the second support portion of the surface frame to secure the liquid crystal panel; and the surface frame decorating plate is connected onto the surface frame, and arranged at an outer side of an edge portion of the glass.

According to embodiments of the present invention, the glass may be tempered glass or organic glass.

According to still another aspect of the present invention, there is provided a display device, including the display module according to the present invention.

The display module according to the present invention may be assembled in a normal manner or in a reverse manner. In the normal assembly, the cooling fin, the light guide plate and the optical film are assembled first, then the surface frame is mounted, and finally the liquid crystal panel is mounted. In the reverse assembly, the liquid crystal panel is assembled and the surface frame is placed first, and then the light guide plate and the optical film are mounted and finally covered with the cooling fin.

The surface frame according to the present invention is provided with a first support portion for supporting the optical film and a second support portion for supporting the liquid crystal panel. Thus, the intermediate frame used for clamping and securing the liquid crystal panel can be omitted. By using the surface frame according to the present invention to assemble a display module, a step of mounting the intermediate frame can be eliminated, and assembly and disassembly are convenient in case of maintenance. The surface frame according to the present invention is applicable to display modules of various display devices, in particular to large-size commercial side-type all-in-one machines.

### BRIEF DESCRIPTION OF THE DRAWINGS

The accompanying drawings, which constitute a part of the specification, are used for providing further understanding of the present invention, and are used for explaining the present invention together with following specific embodiments, but not for limiting the present invention. In the drawings:

FIG. 1 shows a structural schematic diagram of a display module in the prior art;

FIG. 2 shows a structural schematic diagram of a display module according to an embodiment of the present invention; and

FIG. 3 shows a structural schematic diagram of a display module according to another embodiment of the present invention.

### DESCRIPTION OF THE PREFERRED EMBODIMENT

To make those skilled in the art understand the technical solutions of the present invention better, the present invention will be further described in detail below in conjunction with the accompanying drawings and specific implementations.

FIG. 2 shows a structural schematic diagram of a display module according to an embodiment of the present invention.

As shown in FIG. 2, the display module according to the embodiment of the present invention may include a surface frame 10, a liquid crystal panel 20, a cooling fin 32, an optical film 36, a light guide plate 35 and a rear shell 6. The surface frame 10 includes a first support portion 101, a second support portion 102, a side frame 103, and a connection portion 104 for connecting the side frame 103 to outer sides of the first support portion 101 and the second support portion 102.

The first support portion 101 is used for supporting the optical film 36 and the light guide plate 35 and arranged surrounding three edges of the optical film 36 and the light guide plate 35. The second support portion 102 is used for supporting the liquid crystal panel 20 and arranged surrounding three edges of the liquid crystal panel 20. The side frame 103 is connected to the rear shell 6.

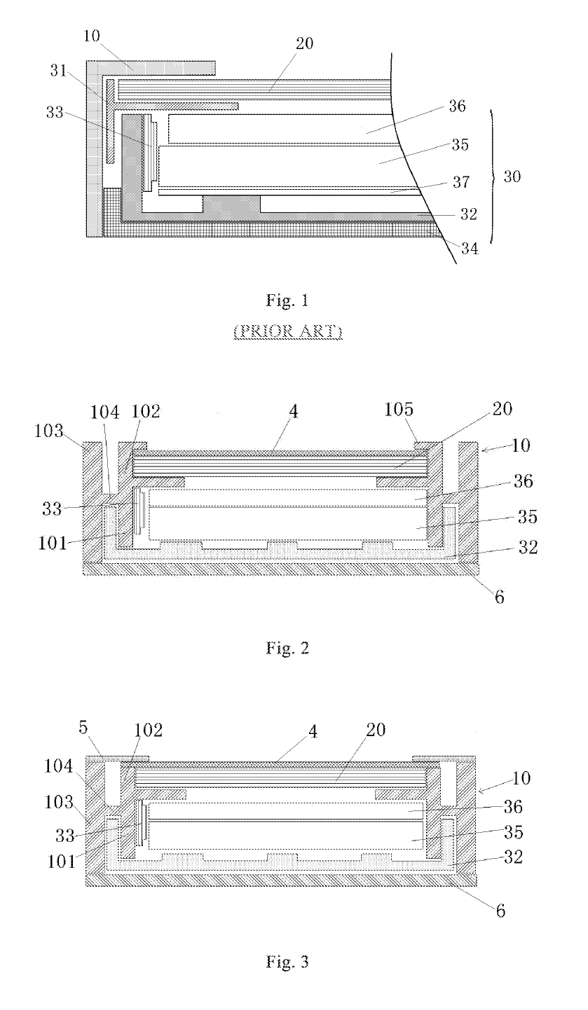

The surface frame 10 according to the present embodiment is provided with the first support portion 101 for supporting the optical film 36 and the second support portion 102 for supporting the liquid crystal panel 20. Hence, when a display module is assembled by using the surface frame 10 according to the embodiment, the intermediate frame (as shown in FIG. 1) used for clamping and securing the liquid crystal panel can be omitted. By using the surface frame 10 according to the embodiment to assemble a display module, a step of mounting the intermediate frame can be eliminated, and assembly and disassembly are convenient in case of maintenance. The surface frame 10 according to the embodiment is applicable to display modules of various display devices, in particular to large-size commercial side-type all-in-one machines.

The surface frame 10 may be made of an aluminum profile, so as to obtain good corrosion resistance and formable property. Additionally, the surface frame 10 may be integrally formed, so that the body of the surface frame 10 is firm and hardly deforms during long-term use.

Referring to FIG. 2 again, the cooling fin 32 may be arranged between the first support portion 101 of the surface frame 10 and the rear shell 6, the optical film 36 and the light guide plate 35 may be arranged inside a space defined by the first support portion 101 of the surface frame 10 and the cooling fin 32, the liquid crystal panel 20 may be arranged on the second support portion 102 of the surface frame 10, and the rear shell 6 may be connected to the side frame 103 of the surface frame 10.

That is, for the display module according to the embodiment, without requiring the intermediate frame as in the prior art, three edges of the liquid crystal panel 20 are surrounded by the second support portion 102 of the surface frame 10, and three edges of the optical film 35 and the light guide plate 35 are surrounded by the first support portion 101 of the surface frame 10, so that the optical film 36, the light guide plate 35 and the liquid crystal panel 20 are secured, thus omitting the step of mounting the intermediate frame. In the case where the three edges of the liquid crystal panels 20 are surrounded by the second support portion 102 of the surface frame 10, the liquid crystal panels 20 may be inserted from a side not surrounded in order to secure the liquid crystal panels 20, thus simplifying the mounting of side-type all-in-one machines.

As shown in FIG. 2, the display module may further include a LED light bar 33 arranged on a side of the first support portion 101 adjacent to the light guide plate 35.

In the prior art, the LED light bar 33 is arranged on a side of the cooling fin 32 adjacent to the light guide plate 35, as shown in FIG. 1. For the display module according to the embodiment, as shown in FIG. 2, the cooling fin 32 and the first support portion 101 surround a space for accommodating the optical film 36 and the light guide plate 35, the tail end of the cooling fin 32 is inserted between the first support portion 101 and the side frame 103, and the LED light bar 33 is provided on the first support portion 101 to make the components more compact.

FIG. 2 shows a case that LED light bar 33 is only provided on one side of the light guide plate 35, but the present invention is not limited thereto. Both sides of the light guide plate 35 may be provided thereon with the LED light bars 33.

As show in FIG. 2, the display module may further include glass 4 arranged at a light outgoing side of the liquid crystal panel 20. That is, the outer surface of the liquid crystal panel 20 is covered with the glass 4 to protect the liquid crystal panel 20 from being damaged. The glass 4 may be tempered glass or organic glass.

The second support portion 102 may be provided with a groove 105 for receiving edges of the glass 4 and the liquid crystal panel 20. The glass 4 may be easily inserted into the groove 105 of the second support portion 102, and it is thus very convenient to mount and remove the glass 4. In the case that the glass 4 is damaged, there is no need to completely disassemble the entire display module, and it only needs to remove the damaged glass from the groove 105 and then insert new glass into the groove 105, thus achieving replacement of the glass 4.

FIG. 3 is a structural schematic diagram of a display module according to another embodiment of the present invention. Different from the embodiment shown in FIG. 2, the display module shown in FIG. 3 may further include a surface frame decorating plate 5.

Referring to FIG. 3, the liquid crystal panel 20 is arranged between the glass 4 and the second support portion 102 of the surface frame 10 to secure the liquid crystal panel 20. The surface frame decorating plate 5 is connected onto the surface frame 10, and arranged at an outer side of an edge portion of the glass 4.

According to the embodiment shown in FIG. 3, the glass 4 is clamped and secured by using the surface frame decorating plate 5 and the second support portion 102, instead of by inserting the glass 4 into the groove 105 of the second support portion 102. The surface frame 10 may be formed to include an internal hollow portion (for example, a space between the second support portion 102 and the side frame 103). In this way, the weight of the surface frame 10 itself may be reduced. Therefore, by mounting the surface frame decorating plate 5 on the outer surface of the surface frame 10, the glass 4 can be clamped and secured, and the hollow portion of the surface frame 10 can be shielded as well.

The display module according to embodiments of the present invention may be assembled in a normal manner or in a reverse manner. In the normal assembly, the cooling fin 32, the light guide plate 35 and the optical film 36 are assembled first, then the LED light bar 33 is placed and the surface frame 10 is inserted, the optical film 36 and the light guide plate 35 may be secured in accommodating space surrounded by the cooling fin 32 and the first support portion 101 of the surface frame 10, finally, the liquid crystal panel 20 is mounted, and the glass 4 is inserted into the groove 105 or the glass 4 is secured by using the surface frame decorating plate 5.

In the reverse assembly, the surface frame decorating plate 5, the glass 4 and the liquid crystal panel 20 are assembled sequentially, then the surface frame 10 is placed and the LED light bar 33, the light guide plate 35 and the optical film 36 are mounted, and finally the cooling fin 32 and the rear shell 6 are mounted as a cover.

Various changes may be made to the embodiments described above by those skilled in the art. For example, a reflector 37 may be provided between the light guide plate 35 and the cooling fin 32, and/or a system board for providing signals or a power supply board for supplying power may be provided between the cooling fin 32 and the rear shell 6, and the like.

The display module according to the embodiments of the present invention may be applicable to various display devices, including, but not limited to, any products or components having a display function such as liquid crystal display panels, TV sets, displays, large-size commercial side-type all-in-one machines, and the like.

It may be understood that the implementations described above are merely exemplary implementations for describing the principle of the present invention, but the present invention is not limited thereto. For a person of ordinary skill in the art, various variations and improvements may be made without departing from the spirit and essence of the present invention, and those variations and improvements shall also be regarded as falling into the protection scope of the present invention.

1.-26. (canceled)

27. A surface frame for a display module, comprising:
a first support portion for supporting an optical film and a light guide plate and arranged surrounding three edges of the optical film and the light guide plate;
a second support portion for supporting a liquid crystal panel and arranged surrounding three edges of the liquid crystal panel;
a side frame connected to a rear shell; and
a connection portion for connecting the side frame to outer sides of the first support portion and the second support portion.

28. A display module, comprising a liquid crystal panel, a cooling fin, an optical film, a light guide plate, a rear shell, and the surface frame according to claim 27.

29. The display module according to claim 28, wherein the cooling fin is arranged between the first support portion of the surface frame and the rear shell.

30. The display module according to claim 28, wherein the optical film and the light guide plate are arranged inside a space defined by the first support portion of the surface frame and the cooling fin.

31. The display module according to claim 28, wherein the liquid crystal panel is arranged on the second support portion of the surface frame.

32. The display module according to claim 28, wherein the rear shell is connected to the side frame of the surface frame.

33. The display module according to claim 28, further comprising a LED light bar arranged on a side of the first support portion adjacent to the light guide plate.

34. The display module according to claim 28, further comprising glass arranged at a light outgoing side of the liquid crystal panel.

35. The display module according to claim 34, wherein the second support portion of the surface frame is provided with a groove for receiving edges of the glass and the liquid crystal panel.

36. The display module according to claim 34, further comprising a surface frame decorating plate,
wherein the liquid crystal panel is arranged between the glass and the second support portion of the surface frame to secure the liquid crystal panel; and
the surface frame decorating plate is connected onto the surface frame and arranged at an outer side of an edge portion of the glass.

37. The display module according to claim 34, wherein the glass is tempered glass or organic glass.

38. A display device, comprising the display module according to claim 28.

39. A method for mounting a display module, comprising steps of:
assembling a cooling fin, a light guide plate and an optical film;
mounting the surface frame according to claim 27, such that the optical film and the light guide plate are secured inside an accommodating space surrounded by the cooling fin and the first support portion of the surface frame; and
mounting the liquid crystal panel such that the liquid crystal panel is arranged on the second support portion of the surface frame.

40. The method according to claim 39, further comprising a step of:
connecting a rear shell to the side frame of the surface frame.

41. The method according to claim 39, further comprising, between the step of assembling the cooling fin, the light guide plate and the optical film and the step of mounting the surface frame, a step of:
providing a LED light bar on a side of the first support portion of the surface frame adjacent to the light guide plate.

42. The method according to claim 39, further comprising a step of:
providing glass on a light outgoing side of the liquid crystal panel.

43. The method according to claim 42, wherein the step of providing glass on a light outgoing side of the liquid crystal panel comprises:
inserting the glass into a groove of the surface frame.

44. The method according to claim 42, wherein the step of providing glass on a light outgoing side of the liquid crystal panel comprises:
providing the liquid crystal panel between the glass and the second support portion of the surface frame to secure the liquid crystal panel; and
connecting a surface frame decorating plate to the surface frame, wherein the surface frame decorating plate is arranged at an outer side of an edge portion of the glass.

45. A method for mounting a display module, comprising steps of:
assembling a liquid crystal panel and the surface frame according to claim 27, such that the liquid crystal panel is arranged on the second support portion of the surface frame; and
mounting an optical film and a light guide plate, and covering the same with a cooling fin, such that the optical film and the light guide plate are secured inside an accommodating space surrounded by the cooling fin and the first support portion of the surface frame.

46. The method according to claim 45, further comprising a step of:
providing glass on a light outgoing side of the liquid crystal panel.

47. The method according to claim 46, wherein the step of providing glass on a light outgoing side of the liquid crystal panel comprises:
inserting the glass into a groove of the surface frame.

48. The method according to claim 46, wherein the step of providing glass on a light outgoing side of the liquid crystal panel comprises:
providing the liquid crystal panel between the glass and the second support portion of the surface frame to secure the liquid crystal panel; and
connecting a surface frame decorating plate to the surface frame, wherein the surface frame decorating plate is arranged at an outer side of an edge portion of the glass.

49. The method according to claim 45, further comprising a step of:
connecting a rear shell to the side frame of the surface frame.

50. The method according to claim 45, further comprising, between the step of assembling the liquid crystal panel and the surface frame and the step of mounting the optical film and the light guide plate and covering the same with the cooling fin, a step of:
providing a LED light bar on a side of the first support portion of the surface frame adjacent to the light guide plate.
